(19) United States
(12) Patent Application Publication
(10) Pub. No.: US 2002/0083592 A1
(43) Pub. Date: Jul. 4, 2002

(54) Cutter structure adapted for shaving

(76) Inventor: Yen-Fu Liao, Shu lin City (TW)

Correspondence Address: BACON & THOMAS PLLC, 625 Slaters Lane - 4th Floor, Alexandria, VA, 22314-1176, US

(21) Appl. No.: 09/749,884

(22) Filed: Dec. 29, 2000

(51) Int. Cl. B26B 19/02; B26B 19/14

(52) U.S. Cl. 30/43.92; 30/43.6

(57) ABSTRACT

A cutter structure adapted for shaving includes an integrally injection molded support member and a spiral blade fitted on the support member or disposed on one side of the support member such that one side of the spiral blade projects from the support member, thereby enabling the cutter to obtain a precise and stable linear axis. In use, the support member is connected to a drive shaft within an electric razor body. When the drive shaft is actuated, the cutter can be brought to reciprocate. The cutter structure can overcome the problems associated with the manufacture of conventional electric razors.

### BACKGROUND OF THE INVENTION

(a) Field of the Invention

The invention relates to a cutter structure adapted for shaving, more particularly to a cutter structure adapted for use in an electric razor.

(b) Description of the Prior Art

A conventional electric razor is shown in FIG. 5. As shown, one end of the razor is provided with a drive device 41. The drive device 41 is connected to a substantially T-shaped blade holder 42. The blade holder 42 is provided with a plurality of blades 43 projecting therefrom such that, when the drive device 41 is actuated, the blade holder 42 along with the blades 43 can be brought to reciprocatingly displace. A multi-seam cover (not shown) is provided externally of the blade holder 42 to effectively prevent direct contact between the blades 43 on the blade holder 42 with the user's skin, thereby achieving the object of shaving.

An disadvantage with the above-described conventional electric razor comprising the blade holder 42 and blades 43 is that during manufacture of the blade holder 42, since the blade holder 42 is an elongate member, it is time and labor consuming to form a plurality of grooves 421 in the blade holder 42 along a horizontal direction and to thereafter insert the blades 43 one by one therein. Besides, due to various factors (human error or machine malfunctioning), the blades 43 are not properly inserted, thereby increasing the faulty product rate and costs.

Furthermore, in terms of the structure of the blade holder 42 and the blades 43, the blade holder 42 can only reciprocate to perform shaving actions, it cannot spirally rotate to perform shaving actions. Therefore, it is desirable to have an electric razor that can improve the problems associated with the manufacture of the conventional electric razor and that can spirally rotate.

### SUMMARY OF THE INVENTION

The primary object of this invention is to provide a cutter structure adapted for shaving to overcome the problems of the prior art. The cutter structure includes an integrally injection molded support member and a spiral blade fitted on the support member or disposed on one side of the support member such that one side of the spiral blade projects from the support member, thereby enabling the cutter to obtain a precise and stable linear axis. In use, the support member is connected to a drive shaft within an electric razor body. When the drive shaft is actuated, the cutter can be brought to reciprocate.

Another object is to provide a cutter structure adapted for shaving in which the one end of the support member that projects from the spiral blade is provided with a plurality of threads that are engageable with a screw rod such that when the screw rod is actuated, the support member can be brought to rotate the spiral blade to spirally rotate. Hence, the cutter structure has the dual functions of performing reciprocating and spiraling movements.

### BRIEF DESCRIPTION OF THE DRAWINGS

The foregoing and other features and advantages of the present invention will be more clearly understood from the following detailed description and the accompanying drawings, in which,

FIG. 1 is a schematic view of a cutter structure of this invention;

FIG. 2 is an exploded schematic view of the embodiment of this invention;

FIG. 3 is an exploded schematic view of another embodiment of this invention;

FIG. 4 is a schematic view of another cutter structure of this invention; and

FIG. 5 is a schematic view of a conventional cutter structure.

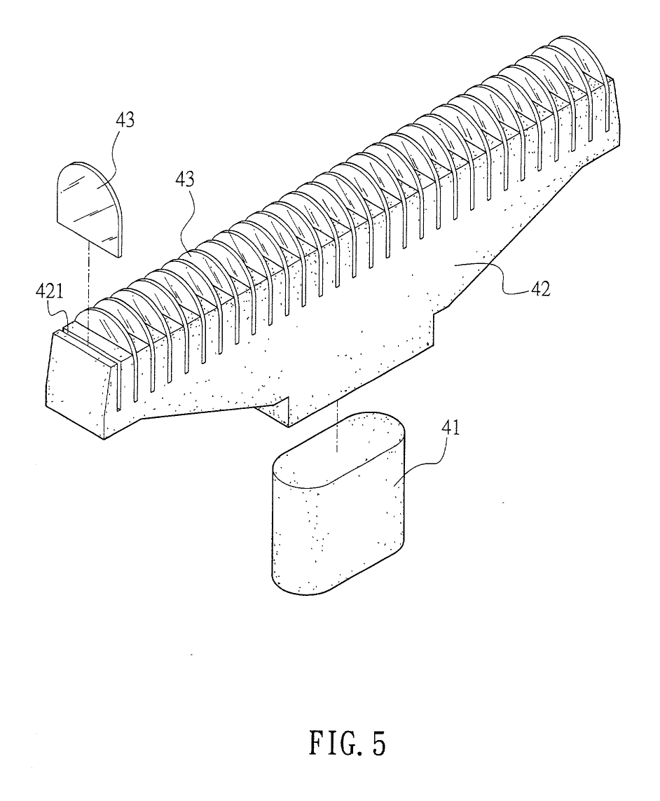

### DETAILED DESCRIPTION OF THE PREFERRED EMBODIMENTS

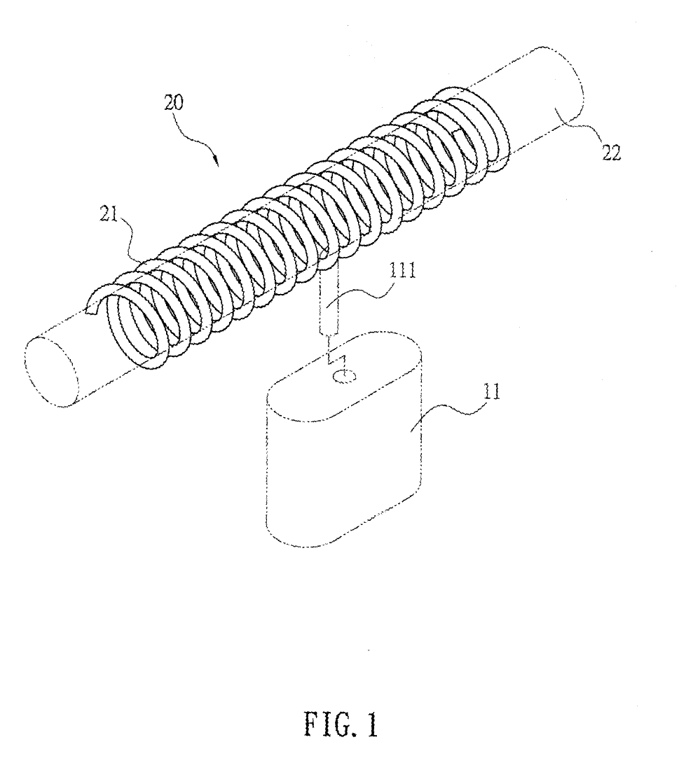

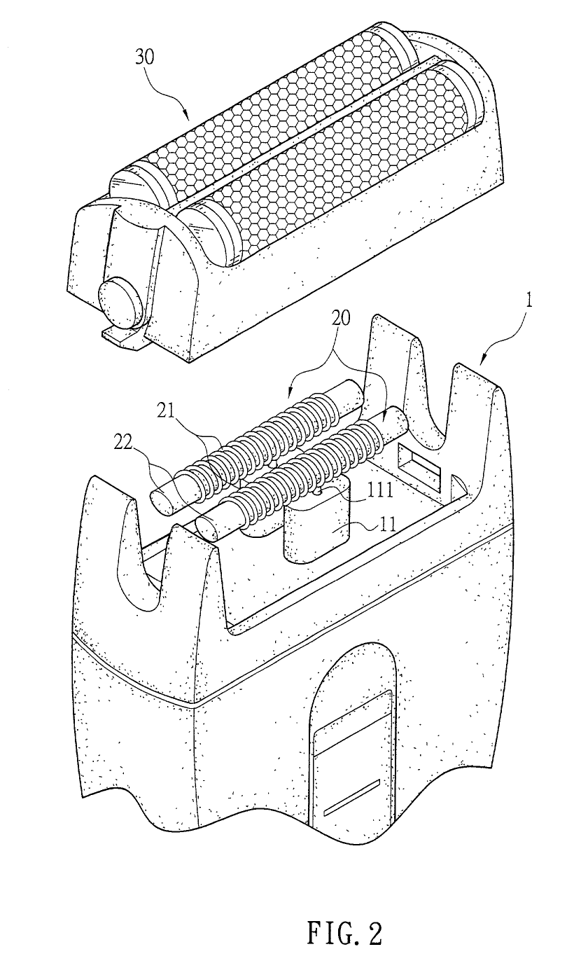

With reference to FIGS. 1 and 2, the preferred embodiment of a cutter structure adapted for shaving according to the invention is adapted for installation inside an electric razor 1 to provide shaving functions. As shown, one end of the razor 1 is provided with a drive device 11 (see FIG. 2). The drive device includes at least one outwardly extending drive shaft 111. The other ends of the drive shafts are respectively connected to a cutter 20.

In this invention, the cutter 20 includes a hollow spiral blade 21 surrounding a support member 22 (see FIG. 1). The support member 22 can be injection molded integrally to fit through the spiral blade 21 and extends from two ends of the spiral blade 21 such that portions of the spiral blade 21 are exposed on the support member 22. During injection molding of the support member 22, it can be formed along with the spiral blade 21 so that the latter surrounds the outer surface of the support member 22, thereby ensuring that contact faces of the support member 22 and the spiral blade 21 are secured connected.

Based on the above construction, when the drive device 11 is actuated, the drive shaft 111 brings the cutter 20 to reciprocatingly displace. Through a multi-seam cover member 30 (see FIG. 2) provided on the outside of the cutter 20, the spiral blade 21 is prevented from directly contacting the skin of the user while performing shaving actions.

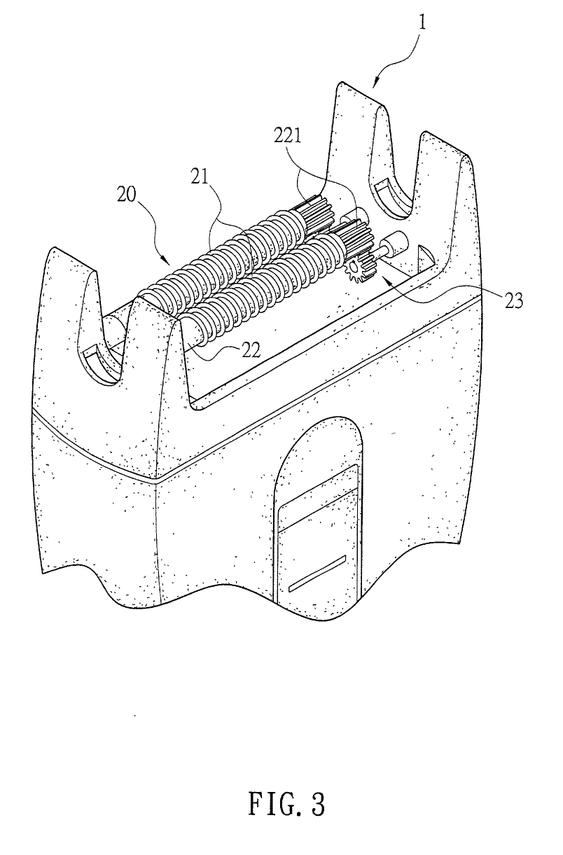

In the above embodiment, referring to FIGS. 2 and 3, one end of the support member 22 that is exposed from the spiral blade 21 may be provided with a plurality of threads 221 that are engageable with a screw rod 23 provided inside the razor 1 such that when the screw rod 23 operates, the support member 22 can be brought to rotate the spiral blade 21.

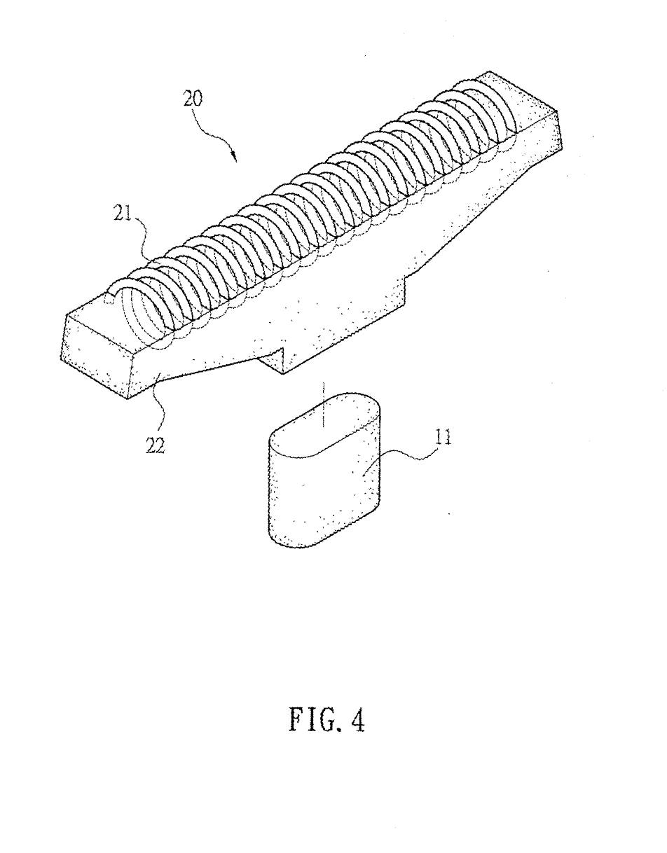

In addition, referring to FIGS. 1 to 4, the spiral blade 21 may be partly embedded in one side of the support member 22 such that one side of the spiral blade 21 is exposed on the support member 22, with the other side embedded in the support member 22. As such, when the drive shaft 11 brings the cutter 22 to reciprocate, the spiral blade on the cutter 20 can be effectively prevented from direct contact with the user's skin through the arrangement of the cover member 30 (see FIG. 2) on the outside of the cutter 20, thereby achieving the object of shaving.

In sum, by virtue of the assembly of the cutter 20 of this invention, the spiral blade 21 can be fitted on the integrally formed injection molded support member 22 or can be partly embedded in the support member 22 such that one side of the spiral blade 21 is exposed projects from the support member 22 to thereby enable the cutter 20 to have a precise and stable linear axis. At the same time, due to the configuration of the spiral blade 21 and the support member 22, the cutter 20 has the dual functions of performing reciprocating and spiraling movements. Hence, the problems associated with the prior can be overcome.

Although the present invention has been illustrated and described with reference to the preferred embodiments thereof, it should be understood that it is in no way limited to the details of such embodiments but is capable of numerous modifications within the scope of the appended claims.

What is claimed is:

1. A cutter structure adapted for shaving, comprising:
a support member; and
a hollow spiral blade provided on said support member to expose portions of an outer edge of said blade.

2. The cutter structure of claim 1, wherein said support member may be fitted through said spiral blade by integral injection molding so as to project from two ends of said spiral blade, with said spiral blade surrounding an outer surface of said support member such that only portions of the outer edge of said spiral blade is exposed.

3. The cutter structure of claim 1, wherein said spiral blade may be provided on one side of said support member such that one side of said spiral blade projects from said support member, with the other side embedded in said support member.

4. The cutter structure of claim 2, wherein one end of said support member that projects from said spiral blade is provided with a plurality of threads that are engageable with a screw rod such that when said screw rod is actuated, said support member can be brought to rotate said spiral blade to spirally rotate.
